(19) United States
(12) Patent Application Publication
(10) Pub. No.: US 2006/0178252 A1
(43) Pub. Date: Aug. 10, 2006

(54) Top plate for paper pallet and method for making same

(76) Inventor: Chih-Ming Hsu, Taoyuan City (TW)

Correspondence Address: PRO-TECHTOR INTERNATIONAL, 20775 Norada Court, Saratoga, CA, 95070-3018, US

(21) Appl. No.: 11/052,963

(22) Filed: Feb. 7, 2005

(51) Int. Cl. B31B 1/00

(52) U.S. Cl. 493/477

(57) ABSTRACT

A method for making a top plate for a paper pallet includes folding a sheet unit in two along a widthwise direction and folding the sheet unit in two or three in a lengthwise direction. Glue or adhesive is applied to obtain a top plate of a firm structure. The sheet unit has a length at least two times the length of a bottom section of the top plate and a width two times the width of the bottom section. Most of the cutting edges of the sheet unit are not exposed.

### BACKGROUND OF THE INVENTION

1. Field of the Invention

The present invention relates to a top plate for a pallet. In particular, the present invention relates to a top plate for a paper pallet. The present invention also relates to a method for making the top plate.

2. Description of the Related Art

Paper pallets are more widely used than conventional wooden pallets and metal pallets, as the paper pallets are light, inexpensive, and recyclable. FIG. 1 of the drawings illustrates a typical paper pallet 90 and comprising a top plate 91 and a plurality of legs 92 supporting the top plate 91.

The top plate 90 is usually made of corrugated paper or thick paper that is cut into a plurality of rectangular or square sheets of a desired area. The sheets are bonded together to form the top plate 91. For a three-ply top plate 91, at least three cutting procedures of the corrugated paper or thick paper is required, which is time-consuming and generates waste as well as results in an increase in the cost. Further, more dusts that cause contamination to the environment and hazard to the health of the workers are generated. Further, the workers are apt to be injured by the sharp edges of the top plate 91. Further, after cargo is placed on the top plate 91, the cargo is tied up with a strip made of, e.g., polyethylene. However, the strip in a tightened state is liable to cause damage to the paper pallet 90.

### SUMMARY OF THE INVENTION

An objective of the present invention is to provide a top plate for a paper pallet that can be produced with less cutting, shorting the production cycle, reducing the amount of dusts as a result of cutting, and allowing mass production.

Another objective of the present invention is to provide a top plate for a paper pallet with less sharp edges.

A further objective of the present invention is to provide a top plate for a paper pallet with improved strength.

Still another objective of the present invention is to provide a method for making a top plate for a paper pallet.

In accordance with a first aspect of the present invention, a method for making a top plate for a paper pallet is provided. The top plate comprises a bottom section having a length and a width. The method comprises the steps of:

preparing a sheet unit having a length at least two times the length of the bottom section of the top plate and a width two times the width of the bottom section;

folding the sheet unit in two along a widthwise direction of the sheet unit by folding two sides of the sheet unit toward a widthwise central portion of the sheet unit, obtaining a first piece and a second piece that are in contact with each other, a sum of a width of the first piece and a width of the second piece being equal to the width of the bottom section;

bonding the first piece and the second piece to the widthwise central portion of the sheet unit;

folding a first portion of the sheet unit along a lengthwise direction of the sheet unit and folding a remaining, second portion of the sheet unit along the lengthwise direction of the sheet unit, obtaining a third piece and a fourth piece that are in contact with each other, a sum of a length of the third piece and a length of the fourth piece being equal to the length of the bottom section;

bonding the third piece and the fourth piece to the first piece and the second piece.

Preferably, the sheet unit is obtained by cutting a web of paper material. In an embodiment of the invention, the web of paper material is folded widthwise to obtain the first piece and the second piece, and the web of paper material is then cut to obtain sheet units having a length equal to the length of the bottom section.

Preferably, each of the width of the first piece and the width of the second piece is ¼ of the width of sheet unit.

In an embodiment of the invention, the length of the sheet unit is two times the length of the bottom section, and with the length of the third piece being different from that of the fourth piece.

In another embodiment of the invention, the length of the sheet unit is three times the length of the bottom section. The length of the third piece is different from that of the fourth piece. The first portion of the sheet unit is folded in three along a lengthwise direction of the sheet unit to obtain an intermediate section that is bonded to the first piece and the second piece. The remaining, second portion of the sheet unit is folded in three along the length direction of the sheet unit another intermediate section that is bonded to the first piece and the second piece.

In accordance with a second aspect of the present invention, a method for making a top plate for a paper pallet is provided. The top plate comprises a bottom section having a length and a width. The method comprises the steps of:

preparing a sheet unit having a length three times the length of the bottom section of the top plate and a width two times the width of the bottom section;

folding the sheet unit in two along a widthwise direction of the sheet unit by folding two sides of the sheet unit toward a widthwise central portion of the sheet unit, obtaining a first piece and a second piece that are in contact with each other, a sum of a width of the first piece and a width of the second piece being equal to the width of the bottom section;

bonding the first piece and the second piece to the widthwise central portion of the sheet unit;

folding ⅓ portion of the sheet unit at a first side of the sheet unit along a lengthwise direction of the sheet unit to obtain a third piece and bonding the third piece to the an intermediate ⅓ portion of the sheet unit;

folding another ⅓ portion of the sheet unit at a second side of the sheet unit along the lengthwise direction of the sheet unit to obtain a fourth piece, each of a length of the third piece and a length of the fourth piece being substantially equal to the length of the bottom section; and

bonding the fourth piece to the second piece.

In an embodiment of the invention, the fourth piece covers a folding section between the third piece and the bottom piece.

In accordance with a third aspect of the present invention, a top plate for a paper pallet is formed of a single sheet unit. The top plate comprises a first piece and a second piece that are folded and bonded widthwise inward and that are in contact with each other. The top plate further comprises a third piece and a fourth piece that are folded and bonded lengthwise and that are in contact with each other, forming a top plate with a bottom section.

Preferably, each of a width of the first piece and a width of the second piece is ½ of the width of the bottom section. The third piece has a length different from that of the fourth piece, and the third piece and the fourth piece are located side by side.

Other objectives, advantages, and novel features of the invention will become more apparent from the following detailed description when taken in conjunction with the accompanying drawings.

### BRIEF DESCRIPTION OF THE DRAWINGS

FIG. 1 is a perspective view of a conventional paper pallet.

FIG. 2 is a perspective view of a first embodiment of a paper pallet in accordance with the present invention.

FIG. 3 is a perspective view of a web of paper material for a top plate of the paper pallet in accordance with the present invention.

FIG. 4 is a perspective view showing a folding procedure of a method for making the top plate of the first embodiment.

FIG. 5 is a perspective view showing another folding procedure of the method for making the top plate of the first embodiment.

FIG. 6 is a perspective view of a final product of the top plate of the first embodiment.

FIG. 7 is a perspective view showing a folding procedure of another folding method for making the top plate of the first embodiment.

FIG. 8 is a perspective view showing another folding procedure of another folding method for making the top plate of the first embodiment.

FIG. 9 is a perspective view showing a folding procedure for making the top plate of a second embodiment.

FIG. 10 is a perspective view showing another folding procedure for making the top plate of the second embodiment.

FIG. 11 is a perspective view of a final product of the top plate of the second embodiment.

FIG. 12 is a perspective view showing a folding procedure for making a top plate of a third embodiment.

FIG. 13 is a perspective view of a final product of the top plate of the third embodiment.

FIG. 14 is a perspective view showing a modified embodiment of the top plate in FIG. 13.

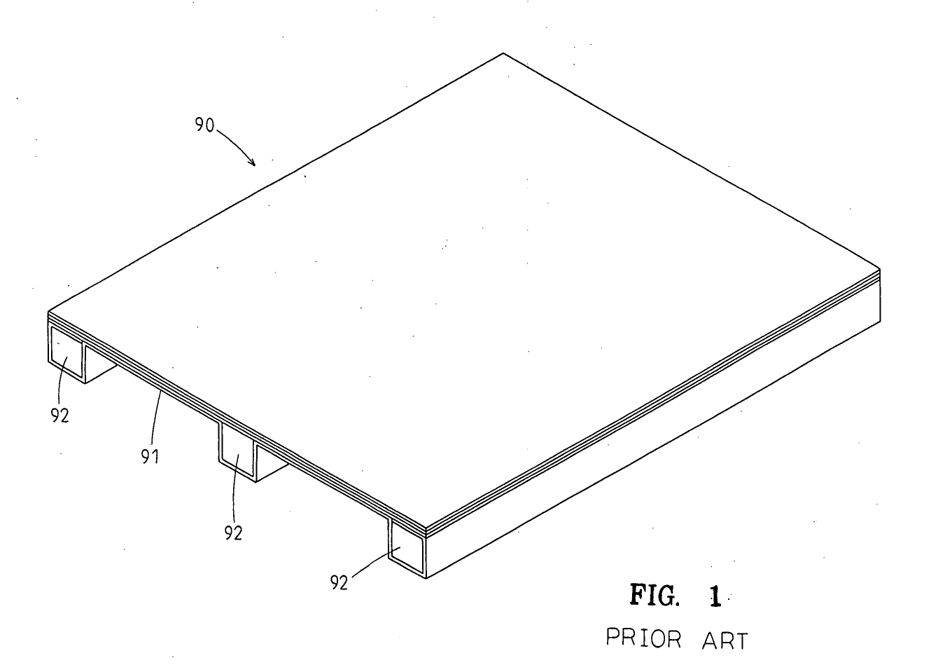

### DETAILED DESCRIPTION OF THE PREFERRED EMBODIMENTS

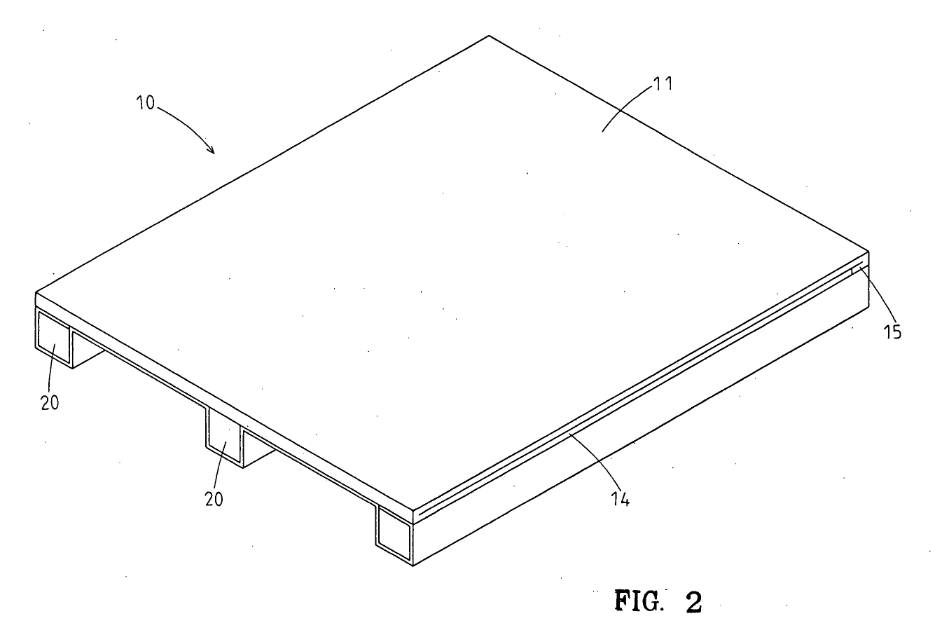

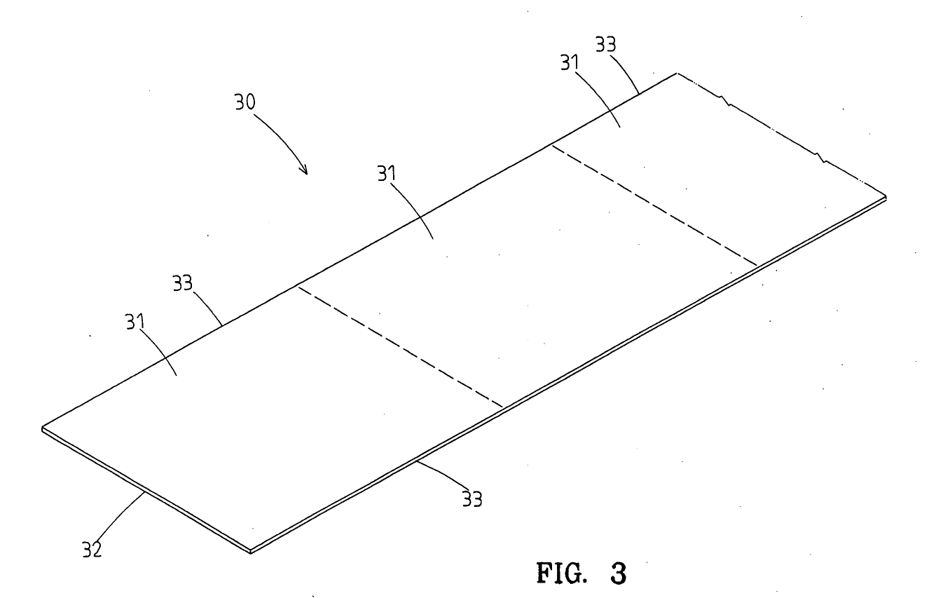

FIG. 2 is a perspective view of a first embodiment of a paper pallet in accordance with the present invention. FIG. 3 is a perspective view of a web of paper material for a top plate of the paper pallet in accordance with the present invention. The paper pallet comprises a top plate 10 and a plurality of legs 20 mounted to an underside of the top plate 10. The top plate 10 in the illustrated embodiment is square. However, the top plate 10 can be rectangular.

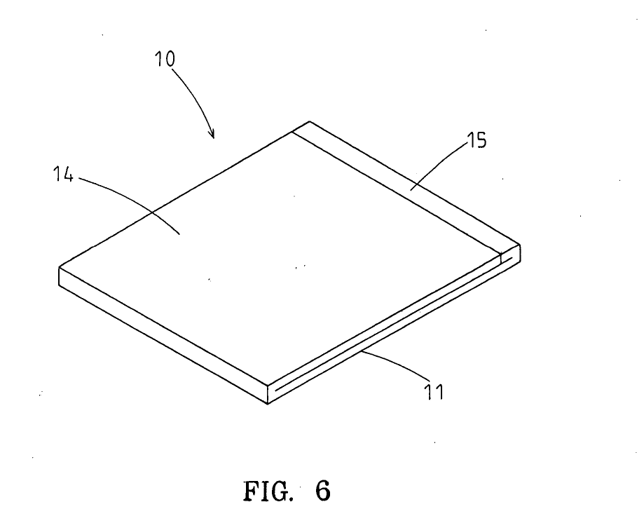

Referring to FIGS. 2 and 3, the top plate 10 is formed by folding a single sheet unit 31 of paper material (corrugated paper or thick paper) that is obtained by cutting a web of paper material. As illustrated in FIG. 3, a plurality of sheet units 31 are obtained by cutting the web of paper material along phantom lines in FIG. 3. The resultant top plate 10 includes a bottom section 11 (FIG. 6). Each sheet unit 31 includes a width 32 that is two times the width of the bottom section 11 of the resultant top plate 10. Further, each sheet unit 31 includes a length that is at least two times the length of the bottom section 11 of the resultant top plate 10.

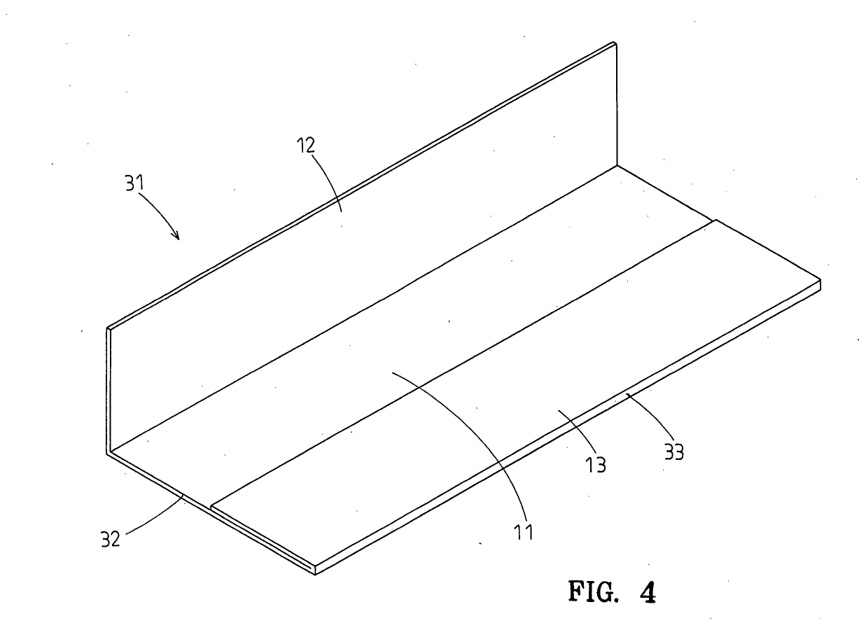

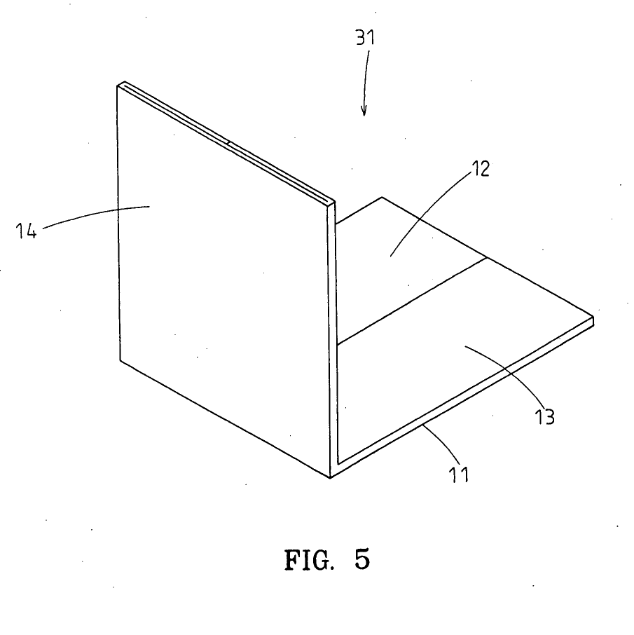

FIG. 4 is a perspective view showing a folding procedure of a method for making the top plate of the first embodiment. FIG. 5 is a perspective view showing another folding procedure of the method for making the top plate of the first embodiment. FIG. 6 is a perspective view of a final product of the top plate of the first embodiment.

Referring to FIG. 4, after cutting, glue (or adhesive) is applied to a portion of a side of the sheet unit 31. In the illustrated embodiment, glue is applied to a central longitudinal region (or widthwise central portion) that is ½ of the overall area of a side of the sheet unit 31, and the sheet unit 31 is folded from two sides toward the central longitudinal region along two folding lines located at ¼ of the width of the sheet unit 31. A first piece 12 and a second piece 13 are obtained and in contact with each other. The sum of a width of the first piece 12 and a width of the second piece 13 is equal to the width of the bottom section 11 of the resultant top plate 10.

Referring to FIG. 5, glue is then applied lengthwise to the first piece 12 and the second piece 13, and the sheet unit 31 is further folded to obtain a third piece 14 and a fourth piece 15 that has a length different from that of the third piece 14. In other words, a first portion of a length of the sheet unit 31 is folded in two to form the third piece 14, and the remaining portion (second portion) of the length of the sheet unit 31 is folded in two to form the fourth piece 15 that is in contact with the third piece 14. The length of the first portion of the sheet unit 31 is different from that of the second portion of the sheet unit 31. The sum of the length of the third piece 14 and the length of the fourth piece 15 is equal to the length of the bottom section 11 of the resultant top plate 10. A two-ply top plate 10 is obtained, as shown in FIG. 6. It is noted that the thickness of the resultant top plate 10 (or final product) is four times the thickness of the sheet unit 31.

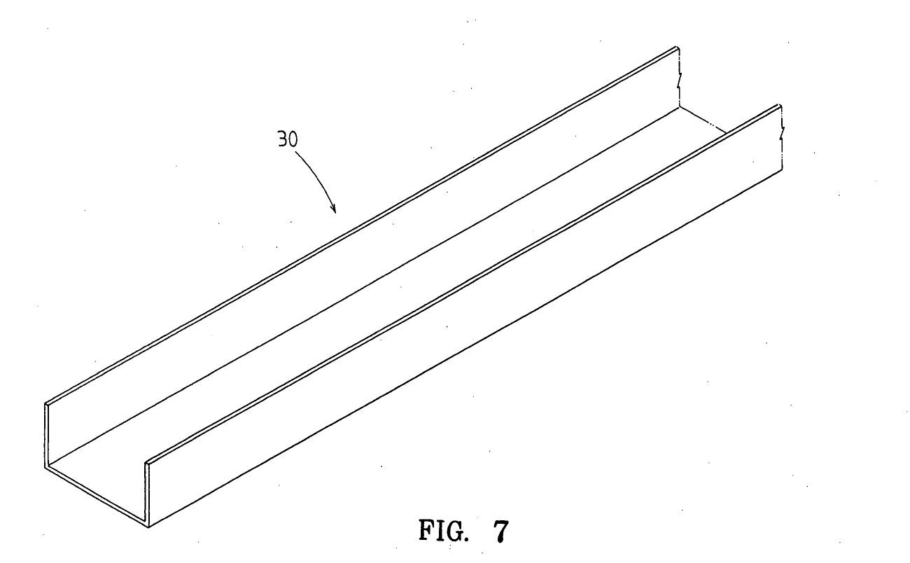

FIG. 7 is a perspective view showing a folding procedure of another folding method for making the top plate of the first embodiment. FIG. 8 is a perspective view showing another folding procedure of another folding method for making the top plate of the first embodiment.

As illustrated in FIG. 7, glue (or adhesive) is applied to the central longitudinal region (or widthwise central portion) that is ½ of the overall area of a side of the web of the paper material, and the web of paper material is folded from two sides toward the central longitudinal region along two folding lines located at ¼ of the width of the web of paper material. Next, the web of paper material is cut along the phantom lines, and the semi-products are folded in a manner similar to the procedures shown in FIGS. 5 and 6 to obtain the top plates 10.

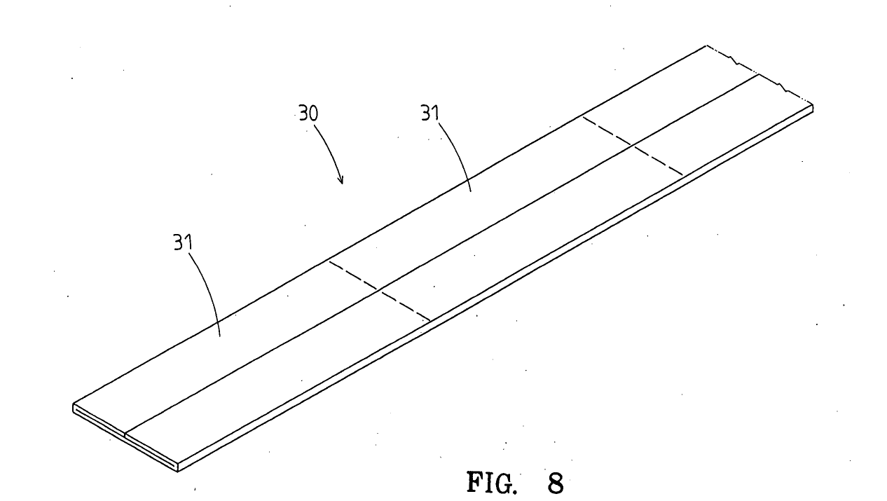

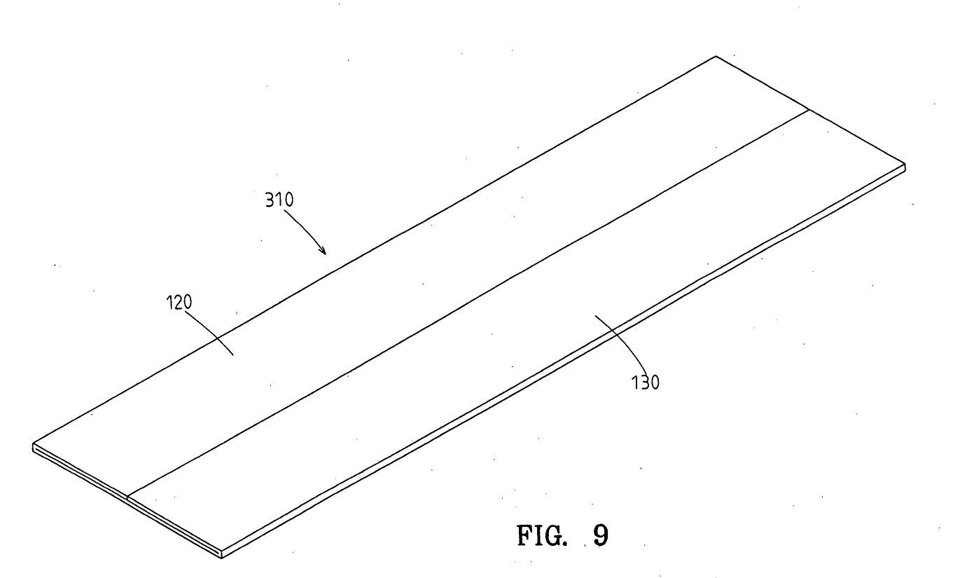

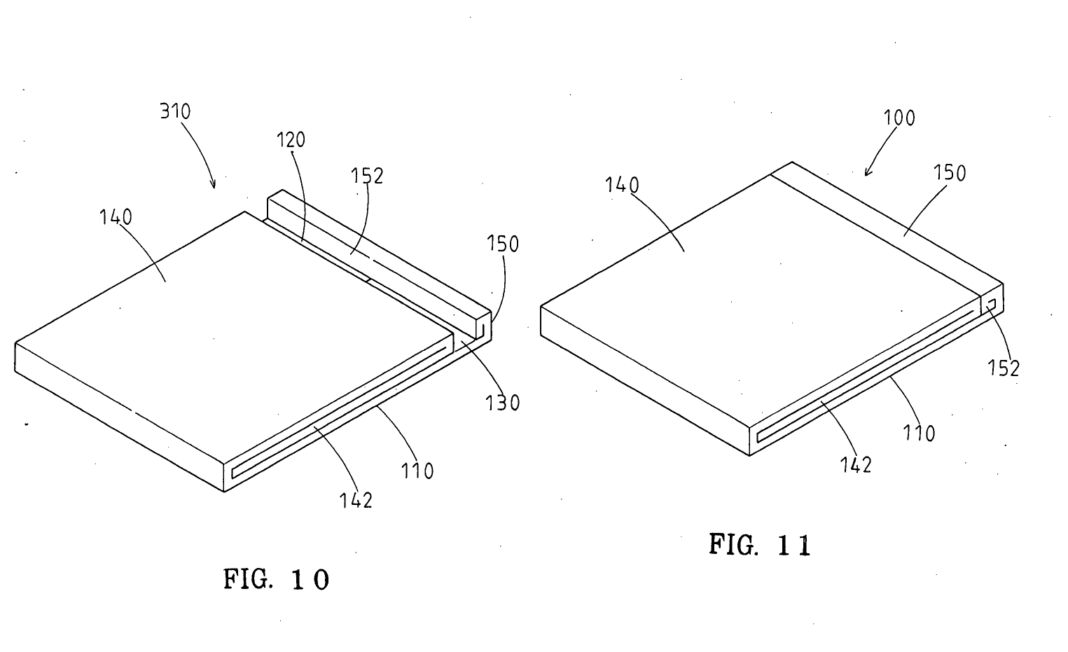

FIG. 9 is a perspective view showing a folding procedure for making the top plate of a second embodiment. FIG. 10 is a perspective view showing another folding procedure for making the top plate of the second embodiment. FIG. 11 is a perspective view of a final product of the top plate of the second embodiment.

In this embodiment, each sheet unit 310 has a length three times the length of the bottom section 110 of the resultant top plate 10. As illustrated in FIG. 9, the sheet unit 310 is folded longitudinally to obtain a first piece 120 and a second piece 130. The sheet unit 310 is then folded in three to obtain a third piece 140 and a fourth piece 150 that has a length different from that of the third piece 140 (see FIG. 11). As illustrated in FIGS. 10 and 11, a first portion of a length of the sheet unit 310 in FIG. 9 is folded in three to form the third piece 140, and the remaining portion (second portion) of the length of the sheet unit 310 is folded in three to form the fourth piece 150 that is in contact with the third piece 140. The length of the first portion of the sheet unit 310 is different from that of the second portion of the sheet unit 310. A three-ply top plate 100 is obtained, as shown in FIG. 11. It is noted that the thickness of the resultant top plate 100 (or final product) is six times the thickness of the sheet unit 310. It is further noted that the first portion folded in three includes an intermediate section 142, and the second portion folded in three includes an intermediate section 152. Both sides of each intermediate section 142, 152 is applied with glue or adhesive for bonding to the first piece 110 and the second piece 120.

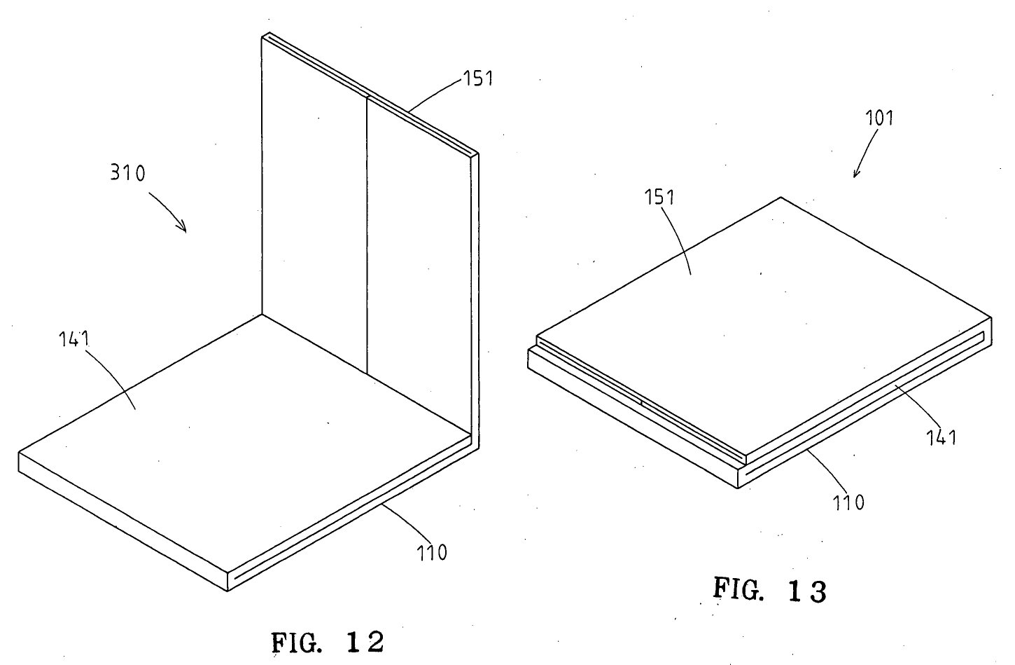

FIG. 12 is a perspective view showing a folding procedure for making a top plate of a third embodiment. FIG. 13 is a perspective view of a final product of the top plate of the third embodiment. The sheet unit 310 in FIG. 9 is substantially folded in three in a different manner. More specifically, the sheet unit 310 is folded at ⅓ portion of the sheet unit at a first side of the sheet unit 310 along a lengthwise direction of the sheet unit 310 to obtain a third piece 141 and the third piece 141 is bonded to an intermediate ⅓ portion of the sheet unit 310. Next, another ⅓ portion of the sheet unit 310 at a second side of the sheet unit 310 is folded along the lengthwise direction of the sheet unit to obtain a fourth piece 151. Each of a length of the third piece and a length of the fourth piece is substantially equal to the length of the bottom section 110. The fourth piece 151 is bonded to the third piece 141. The third piece 141 is thus sandwiched between the bottom piece 110 and the fourth piece 151. It is noted that a portion of the third piece 141 is not covered by the fourth piece 151.

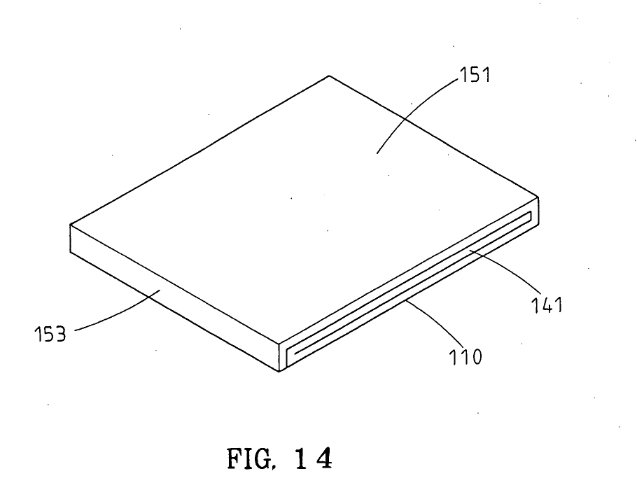

FIG. 14 is a perspective view showing a modified embodiment of the top plate in FIG. 13. In this embodiment, the fourth piece 151 is longer and includes an extension 153 to cover a folding section 115 between the third piece 141 and the bottom piece 110.

The cutting work for making the top plate in accordance with the present invention is less than that required for the prior art top plates. The time for making the top plate is shortened and the cost is cut. The amount of dusts generated during cutting is reduced. Further, most of the cutting edges of the top plate are not exposed to prevent injury to the workers. The strength of the top plate is improved, as the top plate is formed by folding a single sheet unit. Further, the strength of the top plate can be changed by changing the number of folding.

Although specific embodiments have been illustrated and described, numerous modifications and variations are still possible without departing from the essence of the invention. The scope of the invention is limited by the accompanying claims.

What is claimed is:

1. A method for making a top plate for a paper pallet, the top plate comprising a bottom section having a length and a width, the method comprising the steps of:
preparing a sheet unit having a length at least two times the length of the bottom section of the top plate and a width two times the width of the bottom section;
folding the sheet unit in two along a widthwise direction of the sheet unit by folding two sides of the sheet unit toward a widthwise central portion of the sheet unit, obtaining a first piece and a second piece that are in contact with each other, a sum of a width of the first piece and a width of the second piece being equal to the width of the bottom section;
bonding the first piece and the second piece to the widthwise central portion of the sheet unit;
folding a first portion of the sheet unit along a lengthwise direction of the sheet unit and folding a remaining, second portion of the sheet unit along the lengthwise direction of the sheet unit, obtaining a third piece and a fourth piece that are in contact with each other, a sum of a length of the third piece and a length of the fourth piece being equal to the length of the bottom section;
bonding the third piece and the fourth piece to the first piece and the second piece.

2. The method as claimed in claim 1, with the sheet unit being obtained by cutting a web of paper material.

3. The method as claimed in claim 2, with the web of paper material being folded widthwise to obtain the first piece and the second piece, and then cutting the web of paper material to obtain sheet units having a length equal to the length of the bottom section.

4. The method as claimed in claim 1, with each of the width of the first piece and the width of the second piece being ¼ of the width of sheet unit.

5. The method as claimed in claim 1, with the length of the sheet unit being two times the length of the bottom section, and with the length of the third piece being different from that of the fourth piece.

6. The method as claimed in claim 1, with the length of the sheet unit being three times the length of the bottom section, with the length of the third piece being different from that of the fourth piece, with the first portion of the sheet unit being folded in three along a lengthwise direction of the sheet unit to obtain an intermediate section that is bonded to the first piece and the second piece, and with the remaining, second portion of the sheet unit being folded in three along the length direction of the sheet unit another intermediate section that is bonded to the first piece and the second piece.

7. A method for making a top plate for a paper pallet, the top plate comprising a bottom section having a length and a width, the method comprising the steps of:
preparing a sheet unit having a length three times the length of the bottom section of the top plate and a width two times the width of the bottom section;
folding the sheet unit in two along a widthwise direction of the sheet unit by folding two sides of the sheet unit toward a widthwise central portion of the sheet unit, obtaining a first piece and a second piece that are in contact with each other, a sum of a width of the first piece and a width of the second piece being equal to the width of the bottom section;
bonding the first piece and the second piece to the widthwise central portion of the sheet unit;
folding ⅓ portion of the sheet unit at a first side of the sheet unit along a lengthwise direction of the sheet unit to obtain a third piece and bonding the third piece to the an intermediate ⅓ portion of the sheet unit;
folding another ⅓ portion of the sheet unit at a second side of the sheet unit along the lengthwise direction of the sheet unit to obtain a fourth piece, each of a length of the third piece and a length of the fourth piece being substantially equal to the length of the bottom section; and
bonding the fourth piece to the second piece.

8. The method as claimed in claim 7, with the fourth piece covering a folding section between the third piece and the bottom piece.

9. A top plate for a paper pallet, the top plate being formed of a single sheet unit, the top plate comprising a first piece and a second piece that are folded and bonded widthwise inward and that are in contact with each other, the top plate further comprising a third piece and a fourth piece that are folded and bonded lengthwise and that are in contact with each other, forming a top plate with a bottom section.

10. The top plate for a paper pallet as claimed in claim 9, with each of a width of the first piece and a width of the second piece being ½ of the width of bottom section.

11. The top plate for a paper pallet as claimed in claim 9, with the third piece having a length being different from that of the fourth piece, and with the third piece and the fourth piece being located side by side.

12. The top plate for a paper pallet as claimed in claim 11, with the third piece being folded in three along a lengthwise direction of the sheet unit to obtain an intermediate section that is bonded to the first piece and the second piece, and with the fourth piece being folded in three along the length direction of the sheet unit another intermediate section that is bonded to the first piece and the second piece.

13. The top plate for a paper pallet as claimed in claim 9, with each of the third piece and the fourth piece has a length equal to that of the bottom section of the top plate, with the third piece being folded inward and bonded to the first piece and the second piece, and with the fourth piece being folded inward and bonded to the third piece.

14. The top plate for a paper pallet as claimed in claim 13, with the fourth piece further including an extension covering a folding section between the third piece and the bottom section.
